(19) United States
(12) Patent Application Publication
(10) Pub. No.: US 2024/0422655 A1
(43) Pub. Date: Dec. 19, 2024

(54) ACCESS CONTROL FOR ELECTRONIC DEVICE TETHERING WITH SUPPORTED NETWORK SLICING IN CELLULAR NETWORKS

(71) Applicant: GOOGLE LLC, Mountain View, CA (US)

(72) Inventors: Hui Wang, Buffalo Grove, IL (US); Jayachandran Chinnakkannu, Santa Clara, CA (US)

(21) Appl. No.: 18/702,721

(22) PCT Filed: Oct. 21, 2022
(86) PCT No.: PCT/US2022/047383

§ 371 Date: Apr. 18, 2024

Related U.S. Application Data
(60) Provisional application No. 63/270,358, filed on Oct. 21, 2021.

(51) Int. Cl. H04W 48/16; H04W 12/06; H04W 48/18

(52) U.S. Cl. CPC H04W 48/16; H04W 12/06; H04W 48/18

(57) ABSTRACT

A first user equipment (UE) is configured to establish a tethered connection with a second UE. The first UE obtains authentication information associated with the second UE. The first UE controls, based on the authentication information, access of the second UE to at least one network slice of a plurality of network slices provided by a network. The first UE is also configured to receive a request from the second UE to access a network slice provided by the network. If the network slice is not available at first UE, the first UE sends a request to the network for the network slice. The first UE receives an authentication request associated with the network slice from the network and authenticates the second UE for the network slice.

### BACKGROUND

Tethering is a technology that provides network communications for a second device (or devices) through a first device. For example, the first device and the second device may be configured with hardware and software that allow the second device to establish a wired or wireless network (tethered) connection with the first device. The second device transmits network requests to the first device through the tethered connection. The first device relays the network requests received from the second device to the appropriate network destination using communication channels established by the first device with a network, such as a cellular network. When the first device receives data associated with the second device, the first device forwards the data to the second device through the tethered connection. As such, tethering allows the second device to access the network's services using the first device's network connection.

### SUMMARY OF EMBODIMENTS

In accordance with some embodiments, a method, by a first user equipment (UE), includes: establishing a tethered connection with a second UE; identifying a first network slice of a plurality of network slices provided by a network; obtaining authentication information associated with the second UE; and controlling access to the first network slice by the second UE based on the authentication information.

In various embodiments, this method further can include one or more of the following aspects. Identifying a first network slice includes at least one of receiving a request from the second UE associated with the first network slice, or selecting the first network slice from the plurality of network slices. Obtaining authentication information includes sending an authentication request to the second UE and responsive to sending the authentication request, receiving an authentication response from the second UE. The method further includes establishing a secure connection with the second UE, wherein the authentication request is sent to the second UE over the secure connection, and the authentication response is received over the secure connection. Further, the method includes determining that the first network slice is available at the first UE and responsive to the first network slice being available at the first UE, sending the authentication request to the second UE. Obtaining authentication information also includes receiving an authentication request associated with the first network slice from the network; forwarding the authentication request to the second UE; responsive to forwarding the authentication request, receiving an authentication response from the second UE; and sending the authentication response to the network. The method further includes establishing a secure connection with the second UE, wherein the authentication request is forwarded to the second UE over the secure connection, and the authentication response is received over the secure connection. Obtaining authentication information also includes receiving an authentication request associated with the first network slice from the network; responsive to receiving the authentication request, generating an authentication response based on authentication information associated with the second UE; and sending the authentication response to the network. Controlling access to the first network slice is based on the authentication response. The method also includes determining that the first network slice is not available at the first UE; and requesting the first network slice from the network, wherein receiving the authentication request from the network is responsive to requesting the first network slice from the network. Controlling access to the first network slice includes granting the second UE access to the first network slice based on authentication information; and wirelessly communicating data for the second UE over the first network slice using a first upstream link. Controlling access to the first network slice further includes denying the second UE access to the first network slice based on the authentication information; and wirelessly communicating data for the second UE over a second network slice using a second upstream link. The method further includes maintaining the first upstream link concurrently with the second upstream link.

In accordance with some embodiments, a method, by a first user equipment (UE), includes: establishing a tethered connection with a second UE; receiving a request from the second UE to access a network slice provided by a network; determining that the network slice is not available at the first UE; sending a request to the network for the network slice; receiving an authentication request associated with the network slice from the network; and responsive to receiving the authentication request, authenticating the second UE for the network slice.

In various embodiments, this method further can include one or more of the following aspects. Authenticating the second UE includes establishing a secure connection with the second UE. Authenticating the second UE further includes forwarding the authentication request to the second UE; receiving an authentication response to the authentication request from the second UE; and forwarding the authentication response to the network. Authenticating the second UE also includes forwarding the authentication request to the second UE; receiving an authentication response to the authentication request from the second UE; and forwarding the authentication response to the network. Authenticating the second UE further includes, responsive to forwarding the authentication response to the network, determining that the second UE is authorized to access the network slice; and wirelessly communicating data for the second UE over the network slice using an upstream link. Authenticating the second UE also includes, responsive to forwarding the authentication response to the network, determining that the second UE is not authorized to access the network slice; and denying the second UE access to the network slice.

In some embodiments, a device includes a radio frequency (RF) antenna interface; at least one processor coupled to the RF antenna interface; and a memory storing executable instructions, the executable instructions configured to manipulate the at least one processor to perform any of the methods described above and herein.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a diagram illustrating an example wireless communication system employing a host user equipment (UE) implementing access control mechanisms for tethered client UE devices to access network slices implemented by the host UE in accordance with some embodiments.

FIG. 2 is a diagram illustrating an example configuration of a UE implementing network slicing for tethered client UE devices in accordance with some embodiments.

FIG. 3 to FIG. 5 are diagrams together illustrating an example operation of implementing access control mechanisms for tethered UE devices to access network slices in accordance with some embodiments.

FIG. 6 to FIG. 8 are ladder-signaling diagrams illustrating an example operation of the method of FIG. 3 to FIG. 5 in accordance with some embodiments.

### DETAILED DESCRIPTION

Tethering enables devices that may not have hardware or software resources for establishing a connection with a given network to still access the network through another capable device. For example, a second user equipment (UE) device, such as a tablet or notebook computer, may not have the hardware/software to connect with a cellular network. However, the second UE device can establish a wired or wireless tethered connection (downstream link) with a first UE device, such as a smartphone, capable of establishing a connection (upstream link) with the cellular network. The tethered connection enables the second UE device to access the cellular network's services through the first UE device's network connection.

As data and bandwidth allotments have increased for end-users, tethering has become a more viable and useful option for accessing the Internet through cellular networks. However, tethering technology typically is not configured to realize recent advancements in cellular networks. One such advancement is network slicing, which defines different classes of services and provides end-to-end logical networks (network slices) for these services spanning multiple portions of a cellular network. Network slicing allows for network services to be customized based on the requirements of different use cases. The services provided by a Third Generation Partnership Project (3GPP) Fifth Generation New Radio (5G NR) cellular network can be implemented using a network slice, which is instantiated and managed by the network management system of the 5G NR cellular network. In at least some embodiments, a network slice defines a class of service in a cellular network and can be viewed as an end-to-end logical network that spans multiple portions of the cellular network. Each network slice provides service qualities tailored to the use case associated with the network slice, such as low latency, guaranteed bandwidth, support for long-battery-life internet-of-things (IoT) devices, and so on. Also, a network slice can have dedicated resources in the network of a single network operator or across the network of multiple network operators. An end-to-end network slice may be comprised of a radio access network (RAN) slice and/or a core slice.

Different tethered UE devices or different applications on the same tethered UE device may need or can benefit from using different network slices. However, conventional tethering technology usually establishes a single upstream link with the cellular network and is unable to utilize the different network slices offered by a cellular network for tethered UE devices. Also, only authenticated/authorized UE devices, such as the host UE device (or an application thereon), can typically use a network slice or dynamically request, release, or update network slices. Conventional tethering technology generally does not implement network slice access controls for authenticating/authorizing tethered UE devices (or their applications) to perform these actions with respect to network slices provided by the cellular network. As such, conventional tethering technology typically does not allow for tethered UE devices to utilize the different network slices offered by a cellular network.

The present disclosure describes embodiments of systems and methods for implementing access control mechanisms associated with different network slices for tethered connections. In at least some embodiments, a host UE device establishes a connection with a cellular network. As part of the connection process, the cellular network sends network slice information to the host UE device. This network slice information identifies the available network slices provided by the cellular network. In other embodiments, the network slice information is obtained by the host UE device while in an idle mode during a radio/cell search or at some other point in time before connecting to the cellular network. One or more client UE devices establish a tethered connection with the host UE device. The tethered connection may be a wired connection or a wireless connection. The host UE device, in at least some embodiments, uses the network slice information to establish multiple concurrent upstream links with the cellular network and access multiple network slices for tethered client UE devices using the upstream links.

In at least some embodiments, the host UE device includes an access control module for authenticating/authorizing client UE devices and controlling their access to network slices. As described in greater detail below, when a client UE device (or application(s) executing thereon) requests, releases, or updates one or more network slices, the access control module performs one or more authentication operations to determine if the client UE device (or application) is authorized to perform this action(s). The access control module also determines if the client UE device (or application) is authorized to access the requested network slice or a network slice selected by the host UE device for the client UE device.

The access control module, in at least some embodiments, is further configured to coordinate with other modules on the host UE device for controlling access of one or more network slices by client UE devices. For example, when the access control module receives a new slice request from the client UE device, the access control module interacts with a network slicing policy management module to determine whether the request is allowed or not. If the request is allowed, the access control module communicates with an upstream network management module to determine whether the network slice is already available. If the network slice is not already available, the upstream network management module requests a new slice through the connectivity service and telephony service. During this process, there may be authentication interactions among the network, telephony/connectivity service (through the modem), and the client UE device (through the access control module). When the new network slice is ready, the upstream network management module (or access control module) calls the connectivity service (e.g., communicates with the radio access module/modem) and network management service (e.g., communicates with kernel and transmission control protocol (TCP)/internet protocol (IP) stack) to update one or both of network route and IP rules as needed. The policy management module and the access control module may also be updated based on the new network slice. Examples of other modules that the access control module can interact with on the host UE device include a downstream network management module, a tethering state management module, and so on.

As such, the techniques described herein provide for network slice authentication and access control mechanisms at a host UE device implementing network slices for tethered client UE devices in a cellular network. Data associated with tethered client UE devices can benefit from the networking, computing, and storage resources allocated and configured for the network slices carrying the data.

For ease of illustration, the following techniques are described in an example context in which one or more UE devices and radio access networks (RANs) implement one or more radio access technologies (RATs), including at least a Fifth Generation (5G) New Radio (NR) standard (e.g., Third Generation Partnership Project (3GPP) Release 15, 3GPP Release 16, etc.) (hereinafter, “5G NR” or “5G NR standard”). However, it should be understood that the present disclosure is not limited to networks employing a 5G NR RAT configuration, but rather, the techniques described herein can be applied to any combination of different RATs employed at the UE devices and the RANs. It should also be understood that the present disclosure is not limited to any specific network configurations or architectures described herein for implementing network slicing (or equivalent technology) with tethered connections, but instead, techniques described herein can be applied to any configuration of RANs where a host UE device can establish multiple concurrent upstream links to implement different network slices for tethered client UE devices. Also, the present disclosure is not limited to the examples and context described herein, but rather, the techniques described herein can be applied to any network environment where a host UE device implements network slicing for tethered client UE devices.

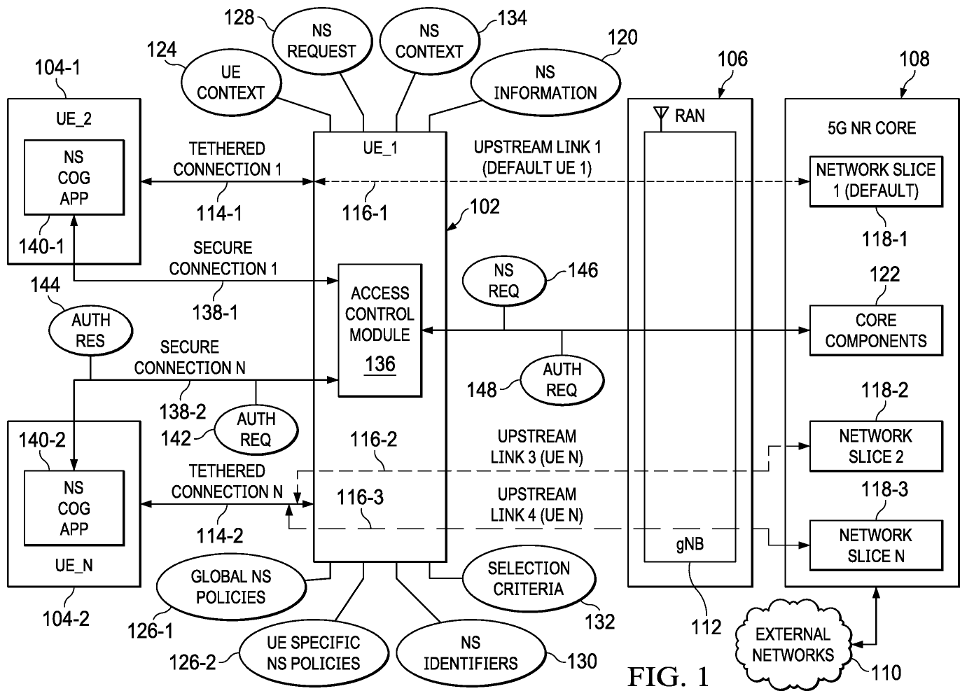

FIG. 1 illustrates an example mobile cellular network 100 employing a set of tethered UE devices 102, 104 implementing network slicing in accordance with some embodiments. It should be understood that the present disclosure is not limited to a cellular network 100, and the techniques described herein apply to other types of wireless communication systems. As shown, the cellular network 100 (also referred to as network 100) includes multiple UE devices 102, 104, one or more RANs 106, and a core network 108. FIG. 1 further shows that one or more external networks 110, such as the Internet or a public switched telephone network (PSTN), are coupled to the cellular network 100 via the core network 108. It should be understood that the cellular network 100 may include additional components not shown in FIG. 1.

The UE devices 102, 104 can include any of a variety of electronic devices capable of wired and/or wireless communications, such as a smartphone, a tablet computer, a notebook computer, a desktop computer, a smartwatch or other wearable computing device, an automobile or other vehicle employing wireless communication services (e.g., for navigation, provision of entertainment services, in-vehicle mobile hotspots, etc.), a gaming device, a media device, an IoT device (e.g., sensor node, controller/actuator node, or a combination thereof), and another device capable of wired and/or wireless communication. In at least one embodiment, the RAN(s) 106 is accessible using, for example, a 5G NR RAT and is connected to one or more other RANs (not shown) via at least the core network 108. A RAN 106 implementing a 5G NR RAT may be referred to as a 5G NR RAN or an NR RAN. One example of a core network 108 in a 5G NR cellular network is Fifth-Generation Core (5GC) network.

Each RAN 106 includes one or more base stations 112 operable to wirelessly communicate with UE devices 102, 104 within signal range, with each or a combination of base stations 112 defining a single “cell” of coverage for the RAN 106. In at least some embodiments, a base station 112 is implemented in a macrocell, microcell, small cell, picocell, or the like, or any combination thereof. Consistent with the terminology employed by the 5G NR standard, a base station 112 implementing a 5G NR RAT is referred to herein as “5G NodeB 112” or “gNB 112”. As is well known in the art, the base stations 112 operate as an “air interface” to establish radio frequency (RF) wireless communication links with UE devices 102, 104, which can be implemented as any suitable type of wireless communication link. These wireless communication links then serve as data and voice paths between the UE devices 102, 104 and the core network 108, which is coupled to one or more of the external networks 110, for providing various services to the UE devices 102, 104. Examples of these services include voice services via circuit-switched networks or packet-switched networks, messaging services such as simple messaging service (SMS) or multimedia messaging service (MMS), multimedia content delivery, presence services, and so on. In at least some embodiments, multiple wireless communication links are aggregated in a carrier aggregation to provide a higher data rate for the UE devices 102, 104. Multiple wireless communication links from multiple base stations 112 can be configured for coordinated multipoint (COMP) communication with the UE devices 102, 104. Additionally, in at least some embodiments, multiple wireless communication links are configured for single-RAT or multi-RAT dual connectivity (MR-DC).

FIG. 1 further illustrates an example configuration of the cellular network 100 that implements network slicing for tethered connections between UE devices 102, 104. In at least some embodiments, one or more client UE devices 104 (illustrated as 104-1 and 104-2) establish a tethered connection 114 (illustrated as 114-1 and 114-2) with a host UE device 102. The tethered connection 114 (also referred to as a downstream link 114) can be established using wired or wireless technologies. For example, a wired connection between the host UE device 102 and a client UE device 104 can be made using a universal serial bus (USB) connection, an ethernet connection, and so on. A wireless connection can be made using, for example, Wi-Fi (that is, one or more of the IEEE 802.11 wireless standards), Bluetooth®, Zigbee®, near-field communication (NFC), and so on.

The tethered connections 114 enable client UE devices 104 to access the core network 108 and the external networks 110 through a communication link(s) 116 (also referred to as an upstream link(s) 116) established between the host UE device 102 and the core network 108 through the RAN 106. For example, the client UE devices 104 transmit network requests to the host UE device 102 over their respective tethered connection 114. The host UE device 102 relays the network requests received from the client UE devices 104 to the appropriate destination through the RAN 106 and core network 108 using the upstream link 116 established by the host UE device 102. The host UE device 102 also receives data associated with one or more of the client UE devices 104 through the upstream link 116 from, for example, an external network 110. The host UE device 102 transmits the received data to the appropriate client UE device 104 through the tethered connection 114. Data, in at least some embodiments, includes singular data packets, multiple data packets, data streams, data bursts, and so on.

In conventional tethered configurations, a host UE device is typically not configured to maintain network slice mappings for data traffic over tethered connections. In these configurations, the host UE usually establishes a single common upstream link with the 5G NR core network for all connected client UE devices. Therefore, only the default network slice currently used by the host UE device can be used for the client UE devices. Also, because the default network slice is used for the client UE device in conventional tethered configurations, the host UE device generally does not implement network slice access control mechanisms for authenticating/authorizing client UE devices to use, request, release, or update different (non-default) network slices.

However, as described in greater detail below, the host UE device 102, in at least some embodiments, can establish multiple concurrent upstream links 116 (illustrated as 116-1 to 116-3) and access multiple network slices 118 (illustrated as network slice 118-1 to 118-3) for tethered client UE devices 104 using the upstream links 116. In at least some embodiments, one or more of the upstream links 116 are a physical upstream link. In other embodiments, one or more of the concurrent upstream links 116 are logical upstream links carried over a physical upstream link. In addition to establishing multiple concurrent upstream links 116 and accessing multiple network slices, the host UE device 102 is configured to authorize/authenticate client UE devices 104 to request, use, release, and update one or more network slices 118.

In at least some embodiments, the host UE device 102 obtains network slice information 120 associated with the network slices 118 of the core network 108. FIG. 1 shows that the core network 108 includes multiple network slices 118. Throughout this description, network slice 118-1 is referred to as the default network slice, and network slices 118-2 and 118-3 are referred to as the non-default network slices. Examples of network slices 118 include network slices configured for 5G NR enhanced mobile broadband (eMBB), 5G ultra-reliable low latency communications (URLLC), 5G NR massive machine type communications (mMTC), massive internet-of-things (MIoT), and so on. The cellular network 100 may include any number and combination of network slices 118, including those not illustrated in FIG. 1.

The network slice information 120, in at least some embodiments, comprises a list or other data structure representing available network slices 118 and information such as an identifier, device requirements and application/service requirements, capabilities, service level agreements (SLAs), configured resources, and the like for each available network slice 118. In at least some embodiments, the network slice information 120 is obtained by the host UE device 102 from a user, a network operator, a base station 112, one or more core network components 122, an external network 110, and so on. In one example, the network slice information 120 is obtained by the host UE device 102 as part of the attachment process with the cellular network 100. In another example, the network slice information 120 is obtained by the host UE device 102 while in an idle mode during a radio/cell search or at some other point in time before attaching to the cellular network 100.

The host UE device 102, in at least some embodiments, selects the default network slice 118-1 based on, for example, a context 124 (also referred to as context information 124) of the host UE device 102 and/or one or more network slice policies 126 described below. In other embodiments, the RAN 106 or a component 122 of the core network 108 managing the network slices 118 selects a default network slice 118-1 for the host UE device 102. For example, the host UE device 102 can transmit a network slice access request to one or more network components 122, such as a network slice management component, along with a context 124 of the host UE device 102. The network slice management component uses the context 124 of the host UE device 102 to select a default network slice 118-1 for the host UE device 102.

In at least some embodiments, a context 124 of a UE device indicates various parameters/attributes of the UE device. Examples of context information include tethered connection parameters such as link type (e.g., wired or wireless, USB, Wi-Fi, Bluetooth®, etc.), link frequency, channel, and so on; client UE device type (e.g., smartphone, tablet computing device, laptop, vehicle, IoT device, gaming device, etc.); media access control (MAC) address of the UE device 102, 104; source internet protocol (IP) address of the data associated with the UE device 102, 104; the destination IP address of the data associated with the UE device 102, 104; the communication port associated with the data of the UE device 102, 104; the applications and/or services on the UE device 102, 104 requesting data; latency requirements of the UE device 102, 104; the mobility status (e.g., in a vehicle, stationary, on a pedestrian, traveling above or below a speed threshold, etc.) of the UE device 102, 104; the type and/or size of data being transmitted and/or requested by the UE device 102, 104; and so on.

The host UE device 102, in at least some embodiments, activates the selected default network slice 118-1 by sending an access request to the RAN 106 and/or one or more core network components 122 for accessing the selected default network slice 118-1. After the host UE device 102 has been authenticated and granted access to the default network slice 118-1 by one or more network components 122, the host UE device 102 uses a default upstream link 116-1 to access the default network slice 118-1 and related services. Data associated with the default network slice 118-1 are wirelessly communicated (e.g., transmitted and/or received) by the host UE device 102 over the default upstream link 116-1. Wireless communication of data, in at least some embodiments, can include one or both of transmitting data or receiving data. The host UE device 102 may establish the upstream link 116-1 with the cellular network 100 before or after selecting the default network slice 118-1. Various mechanisms and techniques may be implemented by the host UE device 102 for establishing an upstream link 116 and accessing a network slice 118, such as those described in the 3rd Generation Partnership Project; Technical Specification Group Services and System Aspects; System Architecture for the 5G System; Stage 2 (Release 15).

In addition to selecting and accessing the default network slice 118-1, the host UE device 102, in at least some embodiments, also selects and accesses one or more network slices 118 for the client UE devices 104 based on, for example, a network slice request(s) 128 received from the client UE device(s) 104, one or more network slice policies (or rules) 126, a combination thereof, or the like. For example, the host UE device 102, in at least some embodiments, receives a request from a client UE device 104 (or an application executing at the client UE device 104) for one or more new (non-default) network slices 118, such as an eMBB network slice. The request can be for one or more specific network slices 118 or types of network slices 118. In at least some embodiments, the host UE device 102 can broadcast/send a list of available network slices 118 provided by the cellular network to one or more of the client UE devices 104 through the tethered connection 114, a network or application layer protocol, and so on. A user, application, or service of the client UE device 104 can select one or more of the available network slices 118.

In other embodiments, the host UE device 102 may automatically select one or more network slices 118 (or types of slices) for a client UE device 104 without receiving a request from the client UE device 104. In these embodiments, the host UE device 102 implements one or more network slice policies (or rules) 126 for determining which of the network slices 118 to select and use for a given client UE device 104. The host UE device 102 may also use the network slice policies 118 to determine if the network slice(s) 118 requested by a client UE device 104 can be used for the client UE device 104. The host UE device 102, in at least some embodiments, obtains the network slice policies 126 from a user, a network operator, one or more of the client UE devices 104, a base station 112, a component 122 of the core network 108, an external network 110, and so on. In one example, a client UE device 104 transmits one or more network slice policies 126 to the host UE device 102 using the tethered connection 114. In at least some embodiments, the network slice policies 126 include, for example, identifiers 130 of the network slices 118 and criteria 132 for each network slice 118 that govern the selection and utilization of the network slices 118 for the client UE devices 104. The host UE device 102 may store and access the network slice policies 126 locally and/or remotely.

In at least some embodiments, the network slice policies 126 are global network slice policies 126-1 applied to one or more client UE devices 104. In other embodiments, one or more network slice policies 126 are UE-specific network slice policies 126-2 defined or configured for a specific client UE device 104. If a client UE device 104 is associated with a UE specific network slice policy 126-2, the host UE device 102 may use the UE specific network slice policy 126-2 to select a network slice 118 for the client UE device 104 instead of a global network slice policy 126-1. In at least some embodiments, the selection criteria 132 of a network slice policy 126 can be defined from the viewpoint of one or both of a UE device 102, 104 and network slice 118. For example, a global network slice policy 126-1 may indicate that an associated network slice 118 may only be selected for a client UE device 104 if the context 124 of the client UE device 104 satisfies the selection criteria 132. In another example, a UE-specific network slice policy 126-2 may include selection criteria 132 that indicates a specific slice context 134 (e.g., parameters, attributes, capabilities, etc.) for a network slice 118 to be selected for a given client UE device 104. In at least some embodiments, the host UE device 102 may use a network slice policy 126 to select a default network slice 118-1. Also, in at least some embodiments, a user or application executing on either the host UE device 102 or client UE device 104 can update a network slice policy 126 defined for the client UE device 104.

In addition to selection criteria 132, the network slice policies 126, in at least some embodiments, also include resource allocation information for the tethered connections 114. For example, the network slice policies 126 can indicate specific resources for allocation to any client UE device 104 or one or more specific client UE devices 104 for a given tethering context. For example, a network slice policy 126 can indicate that for a tethering context in which one or more client UE devices 104 are connected to the host UE device 102 using a Wi-Fi link, resources such as a specific channel, frequency, buffer size, and so on are to be allocated to the one or more client UE devices 104. In at least some embodiments, the resource allocation information may be included in a separate and distinct policy from the network slice policies 126.

A network slice policy 126, in at least some embodiments, may include additional information regarding the management of the network slice policy 126. For example, a network slice policy 126 can indicate that a client UE device 104 is or is not authorized to update the selection rules or criteria of the network slice policy 126; the client UE device 104 needs or does not need to be authorized to update the selection rules or criteria; the client UE device 104 is or is not allowed to request its current network slice 118 or request a new network slice 118; the client UE device 104 needs or does not need to be authorized to request/release a network slice 118; a user of the host UE device 102 or the client UE device 104 can or cannot be shown details of the network slice policy 126 or just a summary overview; and so on. In other embodiments, the additional information may be maintained or accessed separately from the network slice policies 126.

The host UE device 102, in at least some embodiments, determines one or more network slices 118 for a client UE device 104 responsive to the client UE device 104 establishing the tethered connection (downstream link) 114 with the host UE device 102, or upon receiving a request from the client UE device 104 to access the cellular network 100. As part of, or before, the network slice 118 selection process, the host UE device 102 obtains a current context 124 of the client UE device 104 for which a network slice 118 is to be selected. For example, the host UE device 102 can analyze the network slice policies 126 and identify the type of context information 124 for determining which of the network slices 118 can be selected for a client UE device 104. For example, after analyzing a network slice policy 126 for the third network slice 118-3, the host UE device 102 determines that context information 124 such as device type, tethered connection type, tethered connection frequency, and data type are needed to determine if the third network slice 118-3 can be selected for the client UE device 104. The host UE device 102 then communicates with the client UE device 104 to obtain this context information 124. However, in at least some embodiments, this and other context information 124 is already provided to the host UE device 102 as part of establishing the tethered connection 114. As such, the context 124 of the client UE device 104 can be automatically provided to host UE device 102 by the client UE device 104, and/or the host UE device 102 can query the client UE device 104 for context information 124.

The host UE device 102, in at least some embodiments, compares the context 124 of a client UE device 104 to the selection criteria 132 of the network slice policies 126 to determine if the context 124 satisfies the selection criteria 132 of one or more network slices 118. If the context 124 of the client UE device 104 satisfies the selection criteria 132 of a network slice 118, the host UE device 102 selects the network slice 118. If the context 124 of the client UE device 104 does not satisfy the selection criteria 132 of the non-default network slices 118, the host UE device 102, in at least some embodiments, selects the default network slice 118-1 for the client UE device 104. In at least some embodiments, instead of (or in addition to) analyzing a context 124 of a client UE device 104 with respect to the network slice policies 126, the host UE device 102 analyzes a context 134 (also referred to as context information 134) of the network slices 118 with respect to the network slice policies 126. For example, a network slice policy 126 may include selection criteria 132 based on a context information 134 of network slices 118. For example, selection criteria 132 can indicate specific attributes and/or parameters, such as latency, bandwidth, offered services, SLAs, etc., for a network slice 118 to be selected for a given client UE device 104.

If the host UE device 102 selects the default network slice 118-1, the client UE device 104 transmits a first data stream to the host UE device 102 using the first tethered connection 114-1. The host UE device 102 receives the first data stream and transmits the first data stream over the default network slice 118-1 using the default upstream link 116-1. A second data stream is received by the host UE device 102 over the default network slice 118-1. The host UE device 102 determines the second data stream is for the client UE device 104 and transmits the second data stream to the client UE device 104 using the first tethered connection 114-1.

If the client UE device 104 has requested or the host UE device 102 has selected one or more non-default network slices 118-2 or 118-3, the client UE device 104, in at least some embodiments, may need to be authenticated by one or both of the network 100 and host UE device 102 prior to using/accessing, releasing, or updating the requested/selected network slice 118. Therefore, in at least some embodiments, the host UE device 102 includes an access control module 136 for performing authentication/authorization operations and controlling the access to network slices 118 by client UE devices 104. The access control module 136, in at least some embodiments, establishes a connection 138 (illustrated as connection 138-1 and 138-2) with a network slicing cognitive application 140 (illustrated as network slicing cognitive application 140-1 and network slicing cognitive application 140-2) on the client UE device 104 associated with the selected/requested network slice(s) 118. The connection 138, in at least some embodiments, is a secure connection that implements one or more security protocols, such as the Transport Layer Security (TLS) protocol or other applicable protocol. Although, in some embodiments, the connection 138 is a secure connection 138, the connection 138 may not be a secure connection in other embodiments.

The network slicing cognitive application 140 is configured to interact with the access control module 136 of the host UE device 102 for authenticating/authorizing the client UE device 104 and to manage network slice access at the client UE device 104. For example, the network slicing cognitive application 140 requests to access, update, or release one or more network slices 118 associated with the client UE device 104. In other embodiments, the network slicing cognitive application 140 is configured to interact with the access control module 136 of the host UE device 102 for authenticating/authorizing the client UE device 104 while one or more other applications at the client UE device 104 are configured to request access to, update, or release one or more network slices 118 associated with the client UE device 104. The network slicing cognitive application 140, in at least some embodiments, is a stand-alone application at the client UE device 104 or is part of another application at the client UE device 104, capable of using a network slice 118.

In at least some embodiments, the secure connection 138 is established between the access control module 136 and the network slicing cognitive application 140 when the tethered connection 114 is established. In other embodiments, the secure connection 138 is established after the tethered connection 114 has been established. The secure connection 138 can be part of or separate from the tethered connection 114. In at least some embodiments, the client UE device 104 uses the secure connection 138 to send network slice requests 128 to the host UE device 102, receive responses to authentication requests received from the host UE device 102, transmit authentication messages to the host UE device 102, receive authentication messages from the host UE device 102, a combination thereof, and so on. The host UE device 102, in at least some embodiments, uses the secure connection 138 to receive network slice requests 128 from the client UE device 104, transmit authentication messages to the client UE device 104, receive authentication messages from the client UE device 104, a combination thereof, and so on.

Upon receiving a network slice request 128 from the client UE device 104 or the host UE device 102 selecting a network slice 118 for the client UE device 104, the access control module 136 determines if the requested/selected network slice 118 is currently available at the host UE device 102. If the requested network slice 118 is available, the host UE device 102 has already been authenticated/authorized to use the network slice 118 by the network 100. This authentication/authorization, in at least some embodiments, can be carried over to the client UE device 104 such that the client UE device does not need to be authenticated/authorized by the network 100. However, the client UE device 104 may still need to be locally authenticated/authorized by the host UE device 102 to request, use, release, or update the network slice 118. In other embodiments, even if the host UE device 102 has been authenticated/authorized, the client UE device 104 may also need to be authenticated/authorized by the network 100, and the network authentication/authorization process described below is performed. The access control module 136, in at least some embodiments, determines whether network or local authentication/authorization of the client UE device 104 is to be performed based on, for example, the network slice information 120 associated with the requested/selected network slice 118, the network slice policies 126, a combination thereof, or the like. Also, if multiple network slices 118 have been requested/selected, the client UE device 104 may need to be authenticated for one or more of the requested/selected network slices 118 but not for one or more of the remaining requested/selected network slices 118.

If local authentication/authorization of the client UE device 104 is not required for the requested/selected network slice 118, the access control module 136, in at least some embodiments, configures one or both of the host UE device 102 and the client UE device 104 with a network route/rules for enabling the client UE device 104 to use the requested network slice 118 available at the host UE device 102. For example, the access control module 136 sets one or both of the network route and IP rules through a network management service in communication with the kernel or TCP/IP stack of the host UE device 102. The network slicing cognitive application 140 (or related module) of the client UE device 104 sets one or both of the route and IP rules through related system services.

The access control module 136, in at least some embodiments, notifies the client UE device 104 (or application) that the requested network slice 118 is available and can be used by the client UE device 104 (or application). The host UE device 102 establishes an upstream link 116-2 (if not already established) with the cellular network 100 for the client UE device 104 to wirelessly communicate data through the requested/selected network slice 118-2. In other embodiments, the upstream link 116-2 may be established before requesting/selecting the network slice 118-2. In at least some embodiments, if multiple non-default network slices 118-2 and 118-3 were requested/selected, the host UE device 102 establishes a separate upstream link 116-2 and 116-3 for each of the multiple network slices 118-2 and 118-3 to wirelessly communicate data through the requested/selected network slices 118. The host UE device 102 proceeds to transmit and receive data for the client UE device 104 over the requested/selected non-default network slice(s) 118-2 or 118-3 using the associated upstream link(s) 116-2 or 116-3.

When the access control module 136 determines that local authentication of the client UE device 104 is required for the requested network slice 118, the access control module 136 authenticates the client UE device 104 using one or more authentication protocols, such as the Extensible Authentication Protocol (EAP). For example, the access control module 136 sends a request to authenticate 142 (also referred to as authentication request 142) to the network slicing cognitive application 140 (or other component) of the client UE device 104 over the secure connection 138. The authentication request 142 can include, for example, a request for the identity of the client UE device 104 (or application), a message-digest 5 (MD5)-challenge, or other authentication information. The network slicing cognitive application 140 sends a response packet 144 (also referred to as authentication response 144) to the access control module 136 over the secure connection 138 in reply to the request to authenticate 142 being valid. The process of sending request packets from the access control module 136 to the network slicing cognitive application 140 and the network slicing cognitive application 140 sending response packets to the access control module 136, is repeated until the access control module 136 has enough information to determine that authentication of the client UE device 104 (or application) is successful or has failed.

If the access control module 136 is unable to authenticate the client UE device 104 (or application), the access control module 136 does not grant the client UE device 104 (or application) access to the requested/selected network slice 118, and notifies the client UE device 104 (or application) accordingly. However, if authentication of the client UE device 104 (or application) is successful, the access control module 136 configures one or both of the host UE device 102 and the client UE device 104 with one or more of a network route or network rules for the client UE device 104 to use the requested network slice 118 available at the host UE device 102. The access control module 136, in at least some embodiments, then notifies the client UE device 104 (or application) that the requested non-default network slice(s) 118-2 or 118-3 is available and can be used by the client UE device 104 (or application). The host UE device 102 establishes an upstream link(s) 116-2 or 116-3 for the requested/selected non-default network slice(s) 118 (if not already established). The host UE device 102 proceeds to transmit and receive data for the client UE device 104 over the requested/selected non-default network slice 118 using the associated upstream link(s) 116-2 or 116-3.

In some instances, the requested/selected network slice 118 may not be available at the host UE device 102. For example, the host UE device 102 may not have activated the requested/selected network slice 118. If the requested/selected network slice 118 is not available at the host UE device 102, the host UE device 102 attempts to activate the network slice 118 by sending an attach/registration request 146 for the network slice 118 to one or more components 122 of the network, such as a network slice management component. In at least some embodiments, information such as network slice selection assistance information (NSSAI) is included in the attach/registration request 146. A context 124 of one or both of the host UE device 102 and the client UE device 104, in at least some embodiments, is sent to the network component 122 along with the attach/registration request 146. The network component(s) 122 receives and processes the request. It should be understood that different network configurations may process a network slice attach/registration request in different ways. As such, the techniques or mechanisms described herein are not limited to any particular mechanism for a host UE device 102 to obtain a network slice 118 from the network 100.

In at least some embodiments, one or both of the host UE device 102 and the client UE device 104 may need to be authenticated by the network 110 as part of the network slice attachment/registration process. It should be understood that various types of authentication, such as EAP-based authentication, can be performed, and the techniques described herein are not limited to any particular authentication mechanism being implemented by the network 100. In one example, one or more network components 122, such as a network slice management component or other authentication component(s), may send a request for authentication 148 (also referred to as authentication request 148) to the host UE device 102. The access control module 136 of host UE device 102, in at least some embodiments, determines if the authentication request 148 can be satisfied locally or should be forwarded to the client UE device 104. For example, the authentication request 148 may indicate that information, such as an identifier or MD5-challenge associated with the host UE device 102, is being requested by the network component 122. In this example, the access control module 136 determines that the authentication request 148 can be satisfied locally since the network component 122 is requesting information associated with the host UE device 102. In another example, the authentication request 148 may indicate that information, such as an identifier or MD5-challenge, associated with one or both of the client UE device 104 or application executing at the client UE device 104 is being requested by the network component 122. In this example, the access control module 136 determines that the authentication request 148 cannot be satisfied locally and forwards the authentication request to the network slicing cognitive application 140 of the client UE device 104 over the secure connection 138. However, in at least some embodiments, the host UE device 102 maintains authentication-related information associated with the client UE devices 104 and is able to satisfy the authentication request locally. The client UE device 104 can provide the authentication-related information to the host UE device 102 in response to establishing the tethered connection 114 or the secure connection 138, having previously been authenticated, a combination thereof, or the like.

The network slicing cognitive application 140 of the client UE device 104 receives the authentication request 148 forwarded by the host UE device 102 and generates a response packet 144 back to the access control module 136 of the host UE device 102 over the secure connection 138. The response packet 144 includes the authentication information requested by the network component 122 in the authentication request 148. The access control module 136 receives the response packet 144 from the network slicing cognitive application 140 and sends the response packet 144 to the network component 122. This process is repeated until the network component 122 has enough information to determine whether one or more of the host UE device 102 and the client UE device 104 should be granted access to the requested network slice 118. When this determination is made, the network component 122 sends a message to the UE device 102 indicating whether or not access has been granted to the requested network slice 118. If access to the requested network slice 118 is granted, the host UE device 102 establishes an upstream link(s) 116-2 or 116-3 for the requested/selected non-default network slice(s) 118-2 or 118-3 (if not already established). The host UE device 102 proceeds to transmit and receive data for the client UE device 104 over the requested/selected network slice(s) 118-2 or 118-3 using the associated upstream link(s) 116-2 or 116-3.

In at least some embodiments, the access control module 136 may receive a request from the client UE device 104 to release or update the network slice 118. In these embodiments, the access control module 136 can repeat the authentication process described herein to determine if the client UE device 104 (or application) is authorized to release or update a network slice 118. If the client UE device 104 is authorized to request/perform this operation(s), the host UE device 102 proceeds to release or update the network slice 118. Otherwise, the host UE device 102 notifies the client UE device 104 that the release or update request has failed. The host UE device 102 is able to authenticate multiple client UE devices 104 so that multiple client UE devices 104 can concurrently access multiple different network slices 118 available at the host UE device 102. As such, the techniques described herein enable the host UE device 102 to authenticate/authorize one or more client UE devices 104 for using one or more different (non-default) network slices 118 available at the host UE device 102.

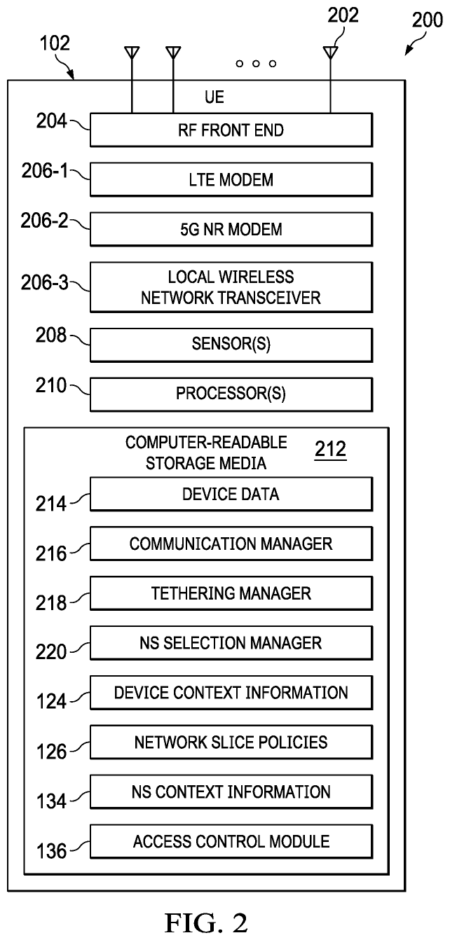

FIG. 2 illustrates an example device diagram 200 of a UE device 102 (or 104). In at least some aspects, the device diagram 200 describes a UE device that can implement various aspects of network slicing for tethered client UE devices. The UE device 102 may include additional functions and interfaces that are omitted from FIG. 2 for the sake of clarity. The UE device 102, in at least some embodiments, includes antennas 202, a radio frequency (RF) front end 204, and one or more RF transceivers 206 (e.g., a 3GPP Fourth Generation (4G) Long Term Evolution (LTE) transceiver 206-1 and a 5G NR transceiver 206-2) for communicating with a base station 112 in a RAN 106, such as a 5G RAN and/or an evolved universal mobile telecommunications system terrestrial radio access network (E-UTRAN). The UE device 102, in at least some embodiments, also includes one or more additional transceivers 206-3, such as a local wireless network transceiver, for communicating over one or more local wireless networks (e.g., wireless local area network (WLAN), Bluetooth, near-field communication (NFC), a personal area network (PAN), Wireless Fidelity Direct (Wi-Fi-Direct), IEEE 802.15.4, ZigBee, Thread, mmWave, and the like) with other UE devices 104, such as those in a tethered configuration with the UE device 102. The RF front end 204, in at least some embodiments, couples or connects the LTE transceiver 206-1, the 5G NR transceiver 206-2, and the local wireless network transceiver 206-3 to the antennas 202 to facilitate various types of wireless communication.

In at least some embodiments, the antennas 202 of the UE device 102 include an array of multiple antennas configured similar to or different from each other. The antennas 202 and the RF front end 204, in at least some embodiments, are tuned to, and/or can be tunable to, one or more frequency bands, such as those defined by the 3GPP LTE, 3GPP 5G NR, IEEE WLAN, IEEE WMAN (wireless metropolitan-area network), or other communication standards. In at least some embodiments, the antennas 202, the RF front end 204, the LTE transceiver 206-1, the 5G NR transceiver 206-2, and/or the local wireless network transceiver 206-3 are configured to support beamforming (e.g., analog, digital, or hybrid), or in-phase and quadrature (I/Q) operations (e.g., I/Q modulation or demodulation operations) for the transmission and reception of communications with the base station 112. By way of example, the antennas 202 and the RF front end 204 operate in sub-gigahertz bands, sub-6GHz bands, and/or above 6 GHz bands defined by the 3GPP LTE, 3GPP 5G NR, or other communication standards.

In at least some embodiments, the antennas 202 include one or more receiving antennas positioned in a one-dimensional shape (e.g., a line) or a two-dimensional shape (e.g., a triangle, a rectangle, or an L-shape) for implementations that include three or more receiving antenna elements. While the one-dimensional shape enables the measurement of one angular dimension (e.g., an azimuth or an elevation), the two-dimensional shape enables two angular dimensions to be measured (e.g., both azimuth and elevation). Using at least a portion of the antennas 202, the UE device 102 can form beams that are steered or un-steered, wide or narrow, or shaped (e.g., such as a hemisphere, cube, fan, cone, or cylinder). The one or more transmitting antennas may have an un-steered omnidirectional radiation pattern or may be able to produce a wide steerable beam. Either of these techniques enables the UE device 102 to transmit a radar signal to illuminate a large volume of space. In some embodiments, the receiving antennas generate thousands of narrow steered beams (e.g., 2000 beams, 4000 beams, or 6000 beams) with digital beamforming to achieve desired levels of angular accuracy and angular resolution.

The UE device 102, in at least some embodiments, includes one or more sensors 208 implemented to detect various properties such as temperature, supplied power, power usage, battery state, or the like. The sensors 208 can include any one or a combination of temperature sensors, thermistors, battery sensors, and power usage sensors.

The UE device 102 also includes at least one processor 210 and a non-transitory computer-readable storage media 212 (CRM 212). The processor 210, in at least some embodiments, is a single-core processor or a multiple-core processor composed of a variety of materials, such as silicon, polysilicon, high-K dielectric, copper, and so on. The computer-readable storage media described herein excludes propagating signals. The CRM 212, in at least some embodiments, includes any suitable memory or storage device such as random-access memory (RAM), static RAM (SRAM), dynamic RAM (DRAM), non-volatile RAM (NVRAM), read-only memory (ROM), or flash memory useable to store device data 214 of the UE device 102. The device data 214 includes, for example, user data, multimedia data, beamforming codebooks, applications, and/or an operating system of the UE device 102, which are executable by the processor 210 to enable user-plane communication, control-plane signaling, and user interaction with the UE device 102.

The CRM 212, in at least some embodiments, also includes a communication manager 216. Alternatively, or additionally, the communication manager 216, in at least some embodiments, is implemented in whole or part as hardware logic or circuitry integrated with or separate from other components of the UE device 102. In at least some embodiments, the communication manager 216 configures the RF front end 204, the LTE transceiver 206-1, the 5G NR transceiver 206-2, and/or the local wireless network transceiver 206-3 to perform one or more wireless communication operations.

In at least some embodiments, the CRM 212 further includes the access control module 136, a tethering manager 218, a network slice (NS) selection manager 220, device context information 124, network slice context information 134, network slice policies 126, and so on. Alternatively, or additionally, one or more of these components, in at least some embodiments, are implemented in whole or part as hardware logic or circuitry integrated with or separate from other components of the UE device 102. One or more of the access control module 136, tethering manager 218, and network slice selection manager 220, in at least some embodiments, configure the RF front end 204, the transceiver(s) 206, processor 210, and/or other components of the UE device 102 to implement the techniques described herein for utilizing network slicing with tethered client UE devices 104 and providing access control mechanisms for network slices 118.

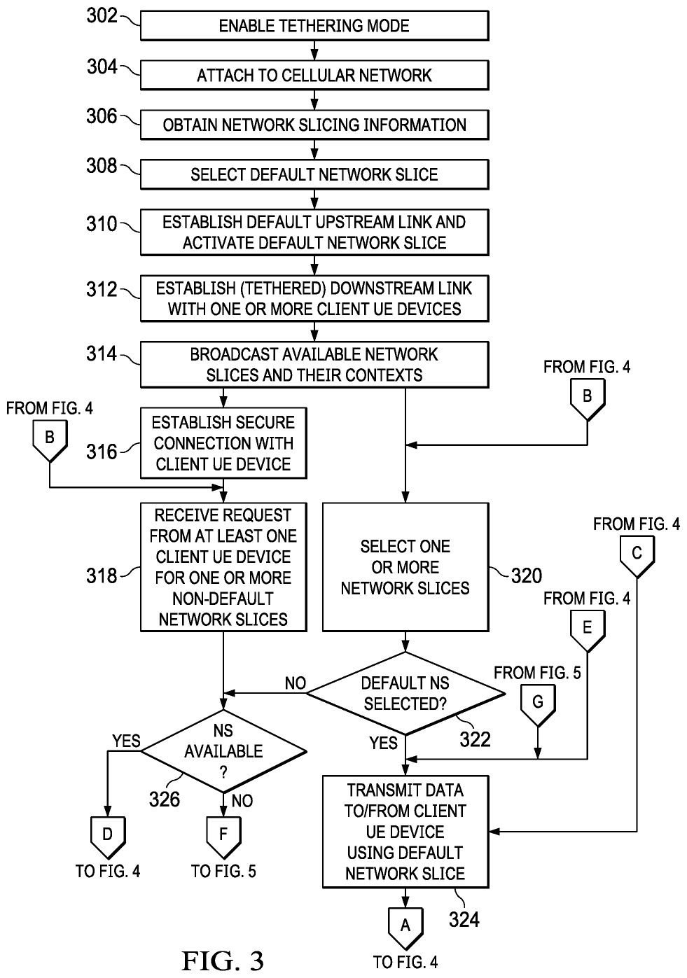

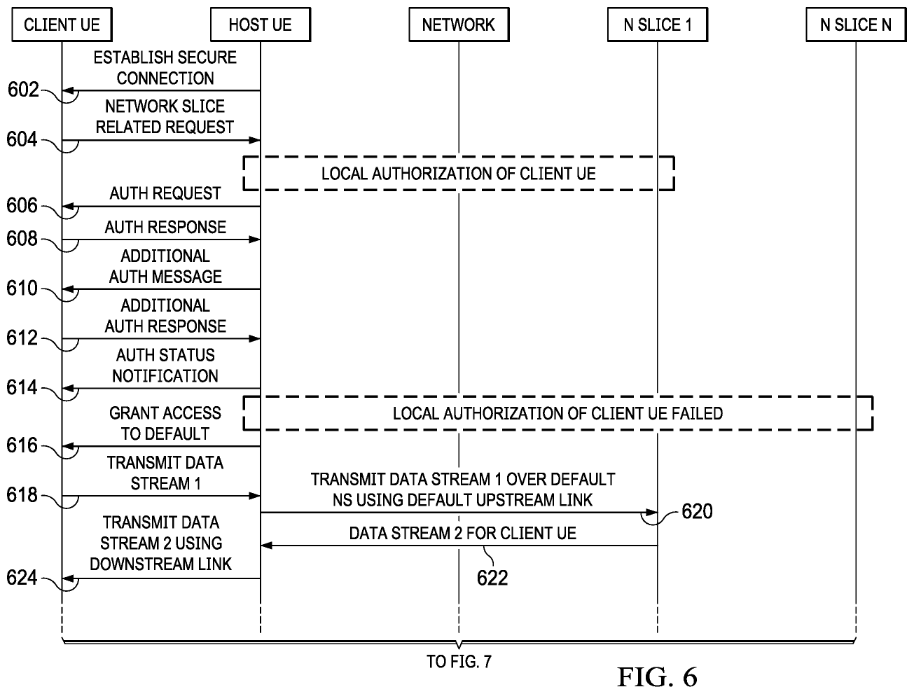

FIGS. 3 to 8 together illustrate an example method 300 for controlling access to network slices 118 by tethered client UE devices 104 in a cellular network 100. Further, the access control processes of method 300 are described with reference to the example transaction (ladder) diagrams of FIG. 6 to FIG. 8. It should be understood the present disclosure is not limited to the illustrated sequence of the operations shown in FIG. 3 to FIG. 8. One or more of the operations may be performed in a different order than shown, and multiple operations may be performed in parallel.

Method 300 is initiated in response to the host UE device 102 determining that a tethering mode should be enabled. In response to this determination, the host UE device 102 enables the tethering mode at block 302. At block 304, the host UE device 102 attaches to the cellular network 100. At block 306, the host UE device 102 obtains network slicing information 120. The network slice information 120, in at least some embodiments, comprises a list of available network slices 118 and context information for each available network slice 118, such as parameters, attributes, capabilities, requirements, and so on of the network slices 118. At block 308, the host UE device 102 selects a default network slice 118-1 based on the network slicing information 120. In other embodiments, the RAN 106, or a core network component 122, selects a default network slice 118-1 for the host UE device 102. At block 310, the host UE device 102 establishes a default upstream link 116-1 and activates the default network slice 118-1. In some embodiments, the default upstream link 116-1 may be established before selecting the default network slice 118-1. At block 312, the host UE device 102 establishes a tethered (downstream) link 114 with one or more client UE devices 104. In at least some embodiments, the host UE device 102 may establish a tethered connection 114 with the one or more client UE devices 104 before selecting or activating the default network slice 118-1.

At block 314, the host UE device 102 broadcasts the list available network slices 118 and the context information 134 (e.g., capabilities) of each network slice 118 responsive to one or more tethered connections 114 having been established. At block 316, the access control module 136 of the host UE device 102 establishes a secure connection 602 (FIG. 6) with the client UE device 104. In one example, the access control module 136 establishes the secure connection 602 with a network slicing cognitive application 140 (or other component) of the client UE device 104. In at least some embodiments, the secure connection 602 is established before, after, or concurrently with another block in method 300. As described below, the host UE device 102 receives one or more network slice-related requests 604 from the client UE device 104 over the secure connection 602. Examples of network slice-related requests include a request to access a non-default network slice 118-2 or 118-3, or a request to release a network slice 118 or update a network slice 118. In at least some embodiments, if the host UE device 102 selects a default network slice 118-1 (or a network slice 118 specified by a network slice policy 126) for the client UE device 104, the secure connection 602 is not established with the client UE device 104. However, in other embodiments, the access control module 136 of the host UE device 102 establishes the secure connection 602 with the client UE device 104 responsive to the host UE device 102 selecting a default network slice 118-1 (or a network slice 118 specified by a network slice policy 126) for the client UE device 104. In at least some embodiments, the access control module 136 establishes the secure connection 602 responsive to detecting a request for a secure connection from the client UE device 104.

At block 318, the host UE device 102 receives a request 604 (FIG. 6) for one or more non-default network slices 118-2 or 118-3 from at least one client UE device 104 over the secure connection 602. In at least some embodiments, the request 604 is a request to access the cellular network 100. The request 604 can be, for example, an explicit request or an implicit request, such as a request for a network slice 118 or the transmission of a data stream. The request 604, in at least some embodiments, can be associated with a single network slice 118 or multiple network slices 118. The flow then continues to block 326 described below.

Alternatively, or additionally, the host UE device 102, at block 320, selects one or more network slices 118 for the client UE device 104 based on, for example, UE context information 124, network slice policies 126, network slice context information 134, a combination thereof, or the like. In at least some embodiments, the host UE device 102 selects a network slice(s) 118 for the client UE device 104 if the request 604 received from the client UE device 104 does not explicitly identify one or more network slices 118. In some instances, the host UE device 102 selects the default network slice 118-1 for the client UE device 104. For example, the context 124 of the client UE device 104 may not have satisfied any of the non-default network slices 118-2 or 118-3, resulting in the default network slice 118-1 being selected. In other instances, the host UE device 102 selects a non-default network slice(s) 118-2 or 118-3 for the client UE device 104. For example, the context 124 of the client UE device 104 may indicate that two applications (or services), such as music streaming and gaming, are executing on the client UE device 104. Therefore, the host UE device 102 selects a network slice 118-2 to wirelessly communicate data associated with the first application, and selects a different network slice 118-3 for wirelessly communicating data associated with the second application. In at least some embodiments, if the host UE device 102 selects a non-default network slice(s) 118-2 or 118-3 for the client UE device 104, the access control module 136 establishes a secure connection 602 with the client UE device 104 if not already established.

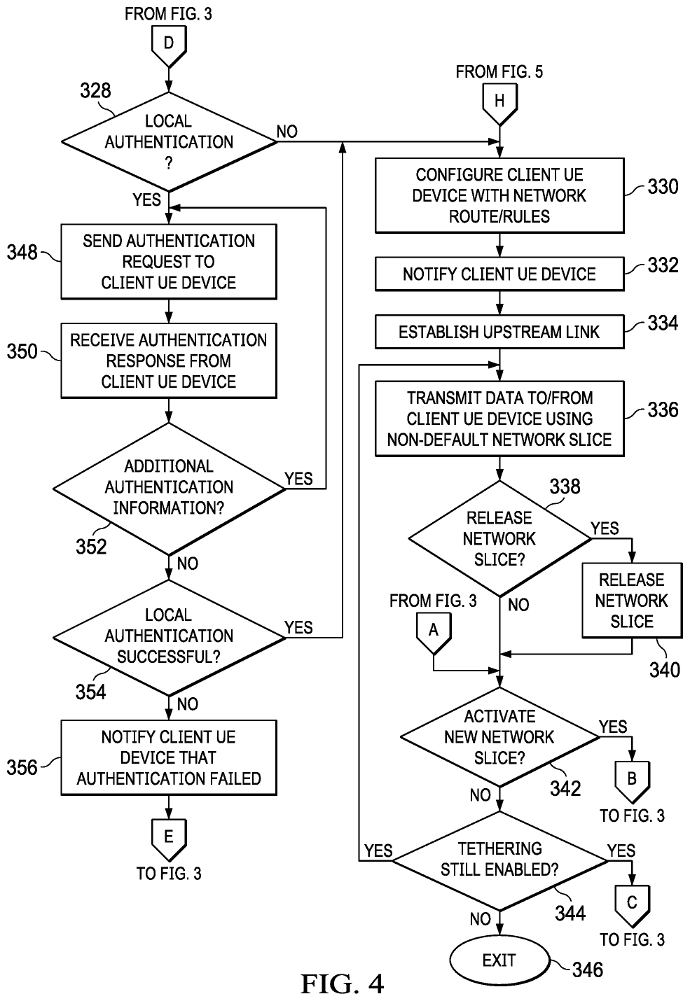

At block 322, the host UE device 102 determines if the default network slice 118-1 was selected for the client UE device 104. At block 324, if the default network slice 118-1 was selected, the host UE device 102 transmits data to and from the client UE device 104 using the default network slice 118-1. The flow continues to block 342 of FIG. 4, and the host UE device 102 determines if the client UE device 104 has requested to activate a new network slice 118. If the client UE device 104 has requested to activate a new network slice 118, the flow returns to one or both of blocks 318 and 320 of FIG. 3. If the client UE device 104 has not requested a new network slice 118, the host UE device 102, at block 344, determines if tethering is still enabled. If tethering is still enabled, the flow returns to block 324, and the host UE device 102 continues to transmit and receive data for the client UE device 104 over the default network slice 118-1 using the associated upstream link(s) 116-1. If tethering is no longer enabled, the process ends at block 346.

Returning to FIG. 3, if the client UE device 104 requests a non-default network slice(s) 118-2 or 118-3 or the host UE device 102 selects one or more non-default network slices 118-2 or 118-3 for the client UE device 104, the host UE device 102, at block 326, determines if the non-default network slice(s) 118-2 or 118-3 is available at the host UE device 102 or if a new network slice 118 is to be obtained. If the non-default network slice(s) 118-2 or 118-3 is available, the flow continues to block 328 of FIG. 4, and the host UE device 102 further determines if local authentication of the client UE device 104 is required. For example, the network slice information 120 or a network slice policy 126 associated with the non-default network slice(s) 118 may indicate that the client UE device 104 is to be authenticated prior to using/accessing, releasing, or updating the network slice 118.

At block 330, if local authentication is not required for the client UE device 104, the host UE device 102 configures at least the client UE device 104 with a network route/rules for enabling the client UE device 104 to use the non-default network slice 118. At block 332, the host UE device 102 notifies the client UE device 104 that the client UE device 104 is authorized to use (or release/update) the network slice(s) 118-2 or 118-3. At block 334, the host UE device 102 establishes an upstream link(s) 116-2 or 116-3 (if not already established) for each non-default network slice 118-2 or 118-3 and activates the network slice(s) 118-2 or 118-3. In at least some embodiments, multiple upstream links 116 can be concurrently active or maintained. At block 346, the host UE device 102 proceeds to transmit and receive data for the client UE device 104 over the non-default network slice(s) 118-2 or 118-3 using the associated upstream link(s) 116-2 or 116-3. For example, the host UE device 102 receives a first data stream and transmits the first data stream over the second network slice 118-2 using the second upstream link 116-2. In at least some embodiments, the host UE device 102 determines which upstream link 116 and network slice 118 is associated with a data stream received from a client UE device 104 based on, for example, a context of the data stream. A context of a data stream includes, for example, the type of data being transmitted, the application/service associated with the data, source IP address, destination IP address, and so on. The host UE device 102 receives a second data stream over the second network slice 118-2. The host UE device 102 determines the second data stream is for the client UE device 104 and transmits the second data stream to the client UE device 104 using the second tethered connection 114-2. Similar operations are performed for additional upstream links 116 and network slices 118 associated with the second (other) client UE device 104.

At block 338, the host UE device 102 determines if the client UE device 104 has requested to release a network slice 118. If the client UE device 104 has requested to release a network slice 118, the host UE device 102, at block 340, releases the network slice 118, and the flow proceeds to block 342. If the client UE device 104 has not requested to release a network slice 118, the host UE device 102, at block 342, determines if the client UE device 104 has requested to activate a new network slice 118. If the client UE device 104 has requested to activate a new network slice 118, the flow returns to one or both of blocks 318 and 320 of FIG. 3. If the client UE device 104 has not requested a new network slice 118, the host UE device 102, at block 344, determines if tethering is still enabled. If tethering is still enabled, the flow returns to block 346, and the host UE device 102 continues to transmit and receive data for the client UE device 104 over the non-default network slice(s) 118-2 or 118-3 using the associated upstream link(s) 116-2 or 116-3. If tethering is no longer enabled, the process ends at block 346.

Returning to block 328, if local authentication is required for the client UE device 104, the access control module 136 sends an authentication request 606 (FIG. 6) to the client UE device 104 at block 348. At block 350, the client UE device 104 responds with an authentication response 608 (FIG. 6) comprising authentication information requested by the access control module 136. At block 352, the access control module 136 determines if additional information is needed to ascertain if the client UE device 104 is authorized to access (or release/update) the non-default network slice(s) 118-2 or 118-3. If additional authentication information is needed, the flow returns to block 348, and additional authentication messages 610 (FIG. 6) and authentication responses 612 (FIG. 6) are transmitted between the host UE device 102 and client UE device 104 over the secure connection 602.

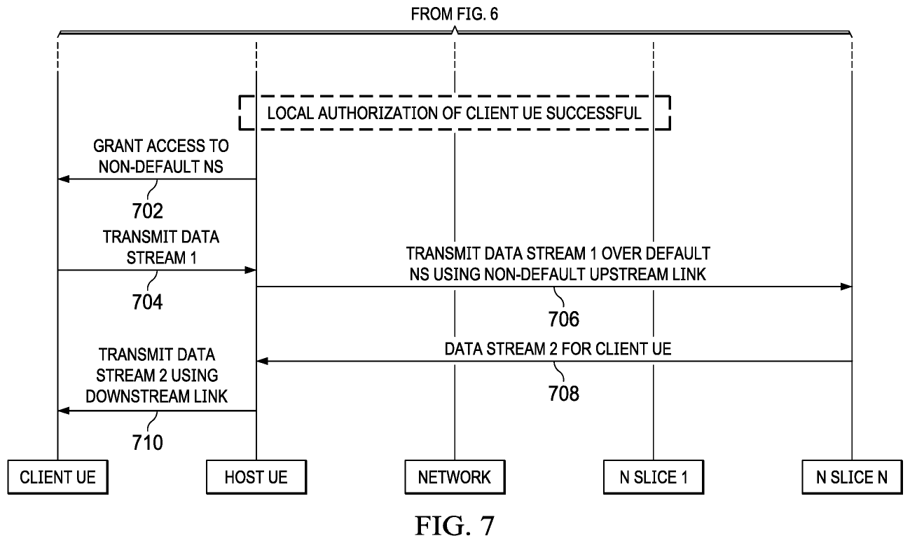

At block 354, if the access control module 136 has obtained sufficient authentication information from the client UE device 104, the access control module 136 determines if local authentication of the client UE device 104 is successful. At block 356, if local authentication is not successful, the access control module 136 sends an authentication status notification 614 (FIG. 6) notifying the client UE device 104 that access to the non-default network slice(s) 118-2 or 118-3 is denied. In some embodiments, the flow continues to block 324, and the access control module 136 grants 616 the client UE device 104 access to the default network slice 118-1 in response to the client UE device 104 being denied access to the non-default network slice(s) 118-2 or 118-3. In this embodiment, the host UE device 102 transmits and receives (618 to 624 in FIG. 6) data for the client UE device 104 over the default network slice 118-1 using the associated upstream link(s) 116-1. If local authentication is successful, the flow returns to block 330, and the access control module 136 configures 702 (FIG. 7) at least the client UE device 104 with a network route/rules for enabling the client UE device 104 to use the non-default network slice(s) 118-2 or 118-3. The operations described above with respect to blocks 332 to 346 are then performed. For example, the host UE device transmits and receives (704 to 710 in FIG. 7) data for the client UE device 104 over the non-default network slice(s) 118-2 or 118-3 using the associated upstream link(s) 116-2 or 116-3.

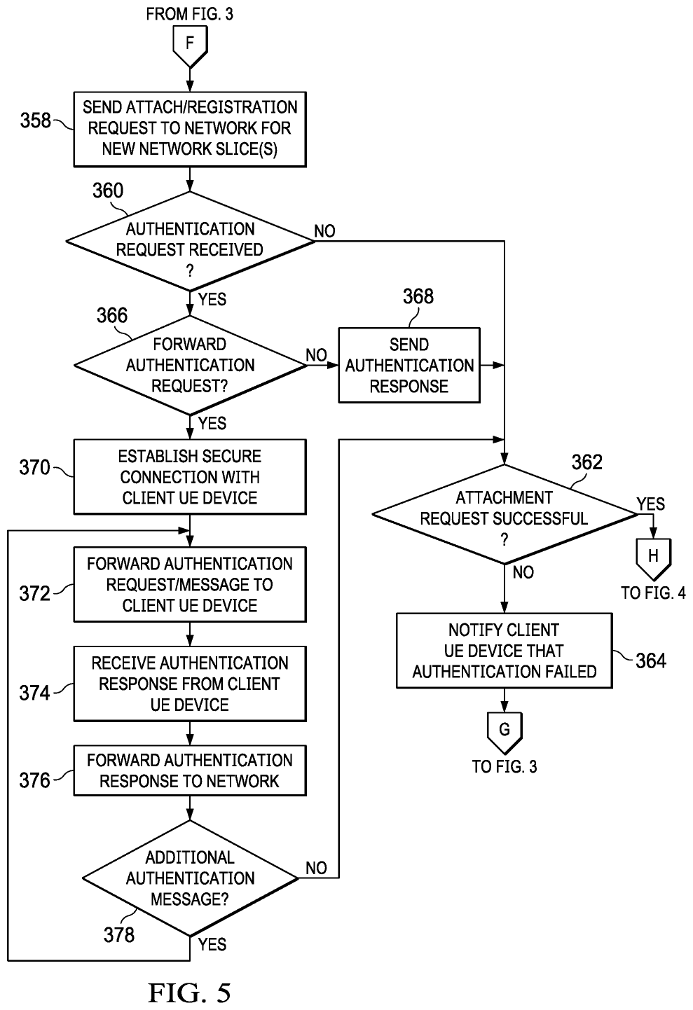

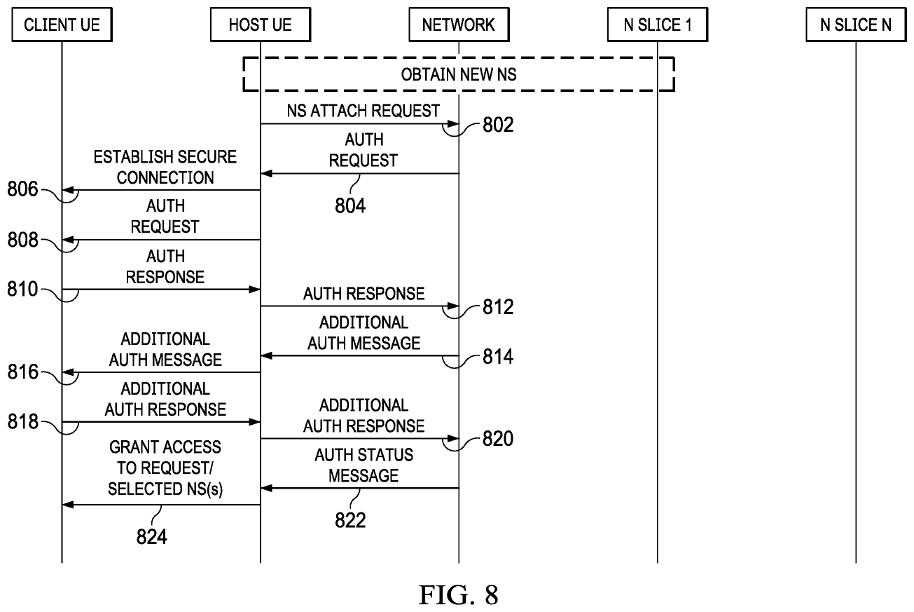

Returning to block 326 (FIG. 3), if a new network slice 118 is to be obtained, the flow continues to block 358 of FIG. 5, and the host UE device 102 sends an attach/registration request 802 (FIG. 8) for the requested/selected non-default network slice(s) 118-2 or 118-3 to one or more components 122 of the network, such as a network slice management component. At block 360, the host UE device 102 determines if an authentication request 804 (FIG. 8) has been received from the network 100. At block 362, if an authentication request 804 has not been received from the network 100, the host UE device 102 determines if the network slice attachment request 802 was successful. Stated differently, the host UE device 102 determines if the network 100 has granted the host UE device 102 access to the non-default network slice(s) 118-2 or 118-3. At block 364, if the attachment request 802 was unsuccessful, the access control module 136 of the host UE device 102 notifies the client UE device 104 that access to the requested/selected non-default network slice(s) 118-2 or 118-3 is denied. The flow continues to block 324, and the host UE device 102 transmits and receives data for the client UE device 104 over the default network slice 118-1 using the associated upstream link(s) 116-1. If the attachment request 802 is successful, the flow returns to block 330, and the host UE device 102 configures at least the client UE device 104 with a network route/rules for enabling the client UE device 104 to use the non-default network slice(s) 118-2 or 118-3. At block 332, the host UE device 102 notifies the client UE device 104 that the client UE device 104 is authorized to use (or release/update) the requested/selected network slice(s) 118. At block 334, the host UE device 102 establishes an upstream link(s) 116-2 or 116-3 (if not already established) for the non-default network slice(s) 118-2 or 118-3, and activates the network slice(s) 118-2 or 118-3.

Returning to block 360, if an authentication request 804 has been received, the access control module 136 of the host UE device 102 determines if the authentication request 804 is to be forwarded to the client UE device 104. For example, the authentication request 804 may request authentication information associated with the host UE device 102 or authentication information associated with the client UE device 104 that is available locally on the host UE device 102. In this example, the access control module 136 determines that the authentication request 804 does not need to be forwarded to the client UE device 104. In another example, the authentication request 804 may request authentication information associated with the client UE device 104 that is not available locally on the host UE device 102. In this example, the access control module 136 determines that the authentication request 804 needs to be forwarded to the client UE device 104. At block 368, if the authentication request 804 does not need to be forwarded to the client UE device 104, the access control module 136 sends an authentication response to the network 110. The flow continues to block 362, and the operations described above with respect to blocks 362 and 364 are performed.

At block 370, if the authentication request 804 is to be forwarded to the client UE device 104, the access control module 136 of the host UE device 102 establishes a secure connection 806 (FIG. 8) with the client UE device 104 if not already established). In one example, the access control module 136 establishes the secure connection 806 with a network slicing cognitive application 140 (or other component) of the client UE device 104. At block 372, the access control module 136 forwards 808 (FIG. 8) the authentication request 804 to the client UE device 104. At block 374, the access control module 136 receives (FIG. 8) an authentication response 810 (FIG. 8) from the client UE device 104 comprising authentication information requested by the network 100. At block 376, the access control module 136 sends 812 (FIG. 8) the authentication response 810 to the network 100. At block 380, the access control module 136 determines if an additional authentication message 814 (FIG. 8) has been received from the network 100. If an additional authentication message 814 has been received, the flow returns to block 372, and the access control module 136 forwards 816 (FIG. 8) the additional authentication message 814 to the client UE device 104 and receives an additional authentication response 818 (FIG. 8) from the client UE device 104. The access control module 136 forwards 820 (FIG. 8) the additional authentication response 818 (FIG. 8) to the network 110.

If (or when) an additional authentication message 814 is not received, the flow continues to block 362, and the operations described above with respect to blocks 362 and 364 are performed. For example, the access control module 136 receives an authentication status message 822 from the network 100 indicating if authentication of one or both of the host UE device 102 or the client UE device 104 was successful. If authentication was not successful, operations such as those described above with respect to block 364 of FIG. 5 are performed. If authentication is successful, the flow returns to block 330, and the access control module 136 configures 824 (FIG. 8) at least the client UE device 104 with a network route/rules for enabling the client UE device 104 to use the non-default network slice(s) 118-2 or 118-3. The operations described above with respect to blocks 332 to 346 and elements 704 to 710 of FIG. 7 are then performed. For example, the host UE device transmits and receives data for the client UE device 104 over the non-default network slice(s) 118-2 or 118-3 using the associated upstream link(s) 116-2 or 116-3.

In some embodiments, certain aspects of the techniques described above are implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium can be in source code, assembly language code, object code, or another instruction format that is interpreted or otherwise executable by one or more processors.

A computer-readable storage medium includes any storage medium or combination of storage media accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any features that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method, by a first user equipment (UE), comprising:
establishing a tethered connection with a second UE;
determining whether local authentication of the second UE is required;
responsive to determining that local authentication of the second UE is required:
sending an authentication request to the second UE; and
responsive to sending the authentication request, receiving an authentication response from the second UE;
determining, based on the authentication response, that the local authentication is successful; and
responsive to determining that the local authentication is successful, granting access of the second UE to a first network slice of a plurality of network slices provided by a network.

2. The method of claim 1, further comprising at least one of receiving, from the second UE, a request for the first network slice or selecting the first network slice from the plurality of network slices.

3. The method of claim 1, further comprising establishing a secure connection with the second UE, wherein the authentication request is sent to the second UE over the secure connection, and the authentication response is received over the secure connection.

4. The method of claim 1, further comprising:
determining that the first network slice is available at the first UE; and
responsive to the first network slice being available at the first UE, sending the authentication request to the second UE.

5. The method of claim 1, wherein granting access to the first network slice comprises:
permitting wirelessly communication of data for the second UE over the first network slice using a first upstream link.

6. The method of claim 5, wherein granting access to the first network slice comprises:
denying access of the second UE to the first network slice based on the authentication response; and
wirelessly communicating data for the second UE over a second network slice using a second upstream link.

7. The method of claim 6, further comprising:
maintaining the first upstream link concurrently with the second upstream link.

8. A method, by a first user equipment (UE), comprising:
establishing a tethered connection with a second UE;
receiving a request from the second UE to access a first network slice provided by a network;
responsive to receiving the request from the second UE, sending a request to the network for the first network slice;
receiving an authentication request associated with the first network slice from the network;
responsive to receiving the authentication request, authenticating the second UE for using the first network slice, wherein the authenticating of the second UE comprises:
determining that the second UE is not authorized to access the first network slice; and denying the second UE access to the first network slice; and
responsive to determining that the second UE is not authorized to access the first network slice, wirelessly communicating data for the second UE over a second network slice.

9. The method of claim 8, wherein authenticating the second UE comprises:
establishing a secure connection with the second UE.

10. The method of claim 8, wherein the sending of the request to the network is further responsive to determining that the first network slice is not available at the first UE.

11. The method of claim 8, wherein the authenticating of the second UE comprises:
forwarding the authentication request to the second UE;
receiving an authentication response to the authentication request from the second UE; and
forwarding the authentication response to the network.

12. The method of claim 11, wherein the authenticating of the second UE comprises:
responsive to forwarding the authentication response to the network, determining that the second UE is authorized to access the first network slice; and
wirelessly communicating data for the second UE over the first network slice using an upstream link.

13. The method of claim 11, wherein determining that the second UE is not authorized to access the network slice is responsive to forwarding the authentication response to the network.

14. A first device comprising:
a radio frequency (RF) antenna interface;
at least one processor coupled to the RF antenna interface; and
a memory storing executable instructions, which when executed by the at least one processor, manipulate the first device to:
establish a tethered connection with a second device;
responsive to determining local authentication of the second device is to be performed:
sending an authentication request to the second device; and
responsive to sending the authentication request, receiving an authentication response from the second device; and
responsive to determining that the local authentication is successful based on the authentication response, granting access of the second device to a first network slice of a plurality of network slices provided by a network.

15. The first device of claim 14, wherein the executable instructions, which when executed by the at least one processor, manipulate the first device to either: receive, from the second device, a request for the first network slice; or select the first network slice from the plurality of network slices.

16. The first device of claim 14, wherein the executable instructions, which when executed by the at least one processor, manipulate the first device to establish a secure connection with the second device, wherein the authentication request is sent to the second device over the secure connection, and the authentication response is received over the secure connection.

17. The first device of claim 14, wherein the executable instructions, which when executed by the at least one processor, manipulate the first device to:
determine that the first network slice is available at the first device; and
responsive to the first network slice being available at the first device, send the authentication request to the second device.

18. The first device of claim 14, wherein the executable instructions, which when executed by the at least one processor, manipulate the first device to grant access to the first network slice by permitting wirelessly communication of data for the second device over the first network slice using a first upstream link.

19. The first device of claim 18, wherein the executable instructions, which when executed by the at least one processor, manipulate the first device to control access to the first network slice further by:
denying the access of the second device to the first network slice based on the authentication response; and
wirelessly communicating data for the second device over a second network slice using a second upstream link.

20. The first device of claim 19, wherein the executable instructions, which when executed by the at least one processor, manipulate the first device to maintain the first upstream link concurrently with the second upstream link.
